(19) United States
(12) Patent Application Publication
(10) Pub. No.: US 2026/0075264 A1
(43) Pub. Date: Mar. 12, 2026

(54) TECHNIQUES FOR OPTIMIZED STORAGE UTILIZATION IN LIVE ORIGIN SERVERS

(71) Applicant: NETFLIX, INC., Los Gatos, CA (US)

(72) Inventors: Xiaomei LIU, Cupertino, CA (US); Rajasekhar UMMADISETTY, North Bend, WA (US); Joseph LYNCH, Gaithersburg, MD (US)

(21) Appl. No.: 18/829,017

(22) Filed: Sep. 9, 2024

(51) Int. Cl. H04N 21/231; H04N 21/2187

(52) U.S. Cl. CPC H04N 21/23103; H04N 21/2187

(57) ABSTRACT

One embodiment of a method for storing data includes determining whether first data to be stored is mutable data that can be modified or immutable data that is not modified, in response to determining that the first data is mutable data, storing the first data in a datastore, and in response to determining that the first data is immutable data, storing the first data in the datastore and in a cache.

### BACKGROUND

### Field of the Various Embodiments

Embodiments of the present disclosure relate generally to computer science and media streaming, and, more specifically, to techniques for optimized storage utilization in live origin servers.

### Description of the Related Art

Media streaming is the process of continuously transmitting media content items over a network for playback by client applications. To stream media content items, a live origin server can be used to transmit the media content items (e.g., video and/or audio) and related metadata to client applications that play back the media content items. The live origin server can receive the media content items from one or more publishing servers, and the live origin server is considered the source of truth for the media content items.

Conventional live origin servers oftentimes write different versions of the same segments of a media content item to storage. The live origin server can implement read after write consistency, in which the live origin server responds to a request for a media content item segment, also referred to herein as a “read request,” with the most updated segment stored in the storage. Further, during live streaming of an event, publishing servers can write many media content item segments that are relatively small in size to a live origin server. For example, a 4-hour event with two second segments and 40 different audio and video encodings can result in 1.44 million small segments. The live origin server maintains a record of the small segments for retrieval by client applications or other services.

One drawback of conventional live origin servers is that these live origin servers are oftentimes not optimized for live streaming. First, conventional live origin servers require, but typically do not include optimized implementations for, strong read after write consistency, in which the live origin server returns the most updated data in storage when receiving a read request for such data. Because conventional live origin servers do not include optimized implementations for strong read after write consistency, such live origin servers can be relatively slow when processing read requests.

Another drawback of conventional live origin servers is that, when publishing servers request to write (also referred to herein as a “write request”) small media content item segments with high frequency, the live origin servers can perform throttling to slow down the write requests. The throttling can result in late publishing of media content item segments which can, in turn, cause the media content item segments to not be immediately available for live streaming to client applications.

Further, conventional live origin servers typically operate in a single cloud region, which is a specific geographic area where a cloud service provider has one or more data centers to deliver cloud-based services. Operating a single cloud region can result in high latency for read and write requests when network jitter occurs. Network jitters are when the time delay between when data is transmitted over a network connection and when the data is received varies significantly.

In addition, when many small media content item segments need to be deleted in a conventional live origin server, the deletion can take a very long time. In conventional live origin servers, media content item segments are typically stored in a distributed storage system. Deleting many small media content item segments from a distribution storage system can be a slow process that takes many hours.

As the forgoing illustrates, what is needed in the art are more effective techniques for implementing live origin servers.

### SUMMARY

One embodiment of the present disclosure sets forth a computer-implemented method for storing data. The method includes determining whether first data to be stored is mutable data that can be modified or immutable data that is not modified. The method further includes, in response to determining that the first data is mutable data, storing the first data in a datastore. In addition, the method includes, in response to determining that the first data is immutable data, storing the first data in the datastore and in a cache.

Another embodiment of the present disclosure sets forth a computer-implemented method for storing media content data. The method includes receiving first media content data. The method further includes storing the first media content data in a first plurality of servers of a datastore that are associated with a first partition.

Another embodiment of the present disclosure sets forth a computer-implemented method for storing data across cloud regions. The method includes storing first data and first metadata in a first datastore included in a first cloud region, where the first metadata is associated with the first data. The method further includes replicating the first metadata from the first datastore to a second datastore included in a second cloud region.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques reduce the latency of read and write requests processed by a live origin server by eliminating the need to maintain data versions during writing of immutable data, as well as the need to perform version checks during reading of immutable data. Further, the immutable data can be stored in a cache, from which the immutable data can be read more efficiently than from a datastore. The disclosed techniques also improve deletion speed in a distributed datastore by deleting entire partitions in which media content item segments are stored, and thereafter deleting data associated with those partitions in the background. In addition, the disclosed techniques can tolerate higher latency jitter impacting the streaming pipeline by hedging read and write requests processed by a live origin server, and the disclosed techniques use multi-cloud region aware live origin servers to request data from different cloud regions when the data is unavailable from any given cloud region. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the live origin server of FIG. 1, according to the various embodiments;

FIG. 3 is a more detailed illustration of the live origin application of FIG. 1, according to various embodiments;

FIG. 4 is a more detailed illustration of partitions in which the live origin application of FIG. 1 can store data, according to various embodiments;

FIG. 5 is a flow diagram of method steps for writing mutable and immutable data, according to various embodiments;

FIG. 6 is a flow diagram of method steps for writing immutable data, according to various embodiments;

FIG. 7 is a flow diagram of method steps for responding to a read request, according to various embodiments;

FIG. 8 is a flow diagram of method steps for performing hedging during processing of a read request, according to various embodiments;

FIG. 9 is a flow diagram of method steps for processing a deletion request, according to various embodiments;

FIG. 10 illustrates live origin servers in two cloud regions, according to various embodiments;

FIG. 11 is a flow diagram of method steps for multi-cloud region aware live origin servers to write data, according to various embodiments; and

FIG. 12 is a flow diagram of method steps for multi-cloud region aware live origin servers to read data, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

As described, one drawback of conventional live origin servers is that these live origin servers are oftentimes not optimized for live streaming. First, conventional live origin servers typically require, but typically do not include optimized implementations for, read after and write consistency. Because conventional live origin servers do not include optimized implementations for read after write consistency, such live origin servers can be relatively slow when processing read requests. When publishing servers request to write small media content item segments with high frequency, the conventional live origin servers can perform throttling to slow down the write requests. The throttling can result in late publishing of media content item segments which can, in turn, cause the media content item segments to not be immediately available for live streaming to client applications. Further, conventional live origin servers typically operate in a single cloud region, which can suffer from high latency for read and write requests in the presence of network jitters, during which the time delay between when data is transmitted over a network connection and when the data is received varies significantly. In addition, the deletion of many small media content item segments in conventional live origin servers can take a very long time when the media content item segments are stored in a distributed storage system.

The disclosed techniques improve live streaming write and read latency. In some embodiments, a distributed datastore is implemented with selective consistency support for reads and writes of media content item manifests. The manifests are tagged as being mutable because data therein can be frequently updated. By contrast, segments of the media content item are tagged as being immutable because data therein is not changed. Selective consistency support is implemented in which consistency is only verified for mutable data to avoid the unnecessary overhead of verifying consistency of immutable data that does change. Because the immutable data does not change, the immutable data can also be cached to further reduce latency when reading the immutable data. In addition, background processes to delete outdated versions of data do not need to operate on immutable data, which further reduces computational overhead.

In some embodiments, different substreams of media content item data, such as substreams of audio and video content on a bitrate ladder that have different bitrates and resolutions, are created. In such cases, the live origin application allocates a separate partition for storing each substream. When a live stream event is restarted, the live origin creates a different ID for the restarted live stream and stores data associated with the restarted live stream event in a new partition. In some embodiments, entire partitions can be deleted by performing a soft delete that makes data associated with the partitions inaccessible and then deleting the data itself. The live origin application can also perform hedging for read and write requests to overcome network jitter that can cause read or write timeouts. During hedging, the live origin application monitors the average time for read and write requests. If a response to a given request is taking more than the average time, the live origin sends one or more requests to other servers and returns the fastest response from one of the servers to which requests were sent.

In some embodiments, live origin applications are multi-cloud region aware. In such cases, one or more cloud regions can each host an encoding pipeline that writes to a corresponding live origin application. When a live origin application in one cloud region writes data and corresponding metadata in a datastore and/or cache of the cloud region, the metadata and optionally the data can be asynchronously replicated to other cloud regions. The metadata for media content item segments is written to all primary and secondary regions, while the live origin application determines the datastores that manifest information and media content item segments are replicated to based on configuration information from an upstream pipeline component, such as a packager, that can choose to (or not to) publish media content item segments and associated manifest information to multiple cloud regions. For read requests, the live origin searches for data associated with the read request using the metadata in the datastore. The live origin then retrieves the manifests or the segments referenced by the metadata from the same region, whether the data was written directly to the cloud region or asynchronously replicated to the cloud region.

Advantageously, the disclosed techniques reduce the latency of read and write requests processed by a live origin server by eliminating the need to maintain data versions during writing of immutable data, as well as the need to perform version checks during reading of immutable data. Further, the immutable data can be stored in a cache, from which the immutable data can be read more efficiently than from a datastore. The disclosed techniques also improve deletion speed in a distributed datastore by deleting entire partitions in which media content item segments are stored, and thereafter deleting data associated with those partitions in the background. In addition, the disclosed techniques can tolerate higher latency jitter impacting the streaming pipeline by hedging read and write requests processed by a live origin server, and the disclosed techniques use multi-cloud region aware live origin servers to request data from different cloud regions when the data is unavailable from any given cloud region.

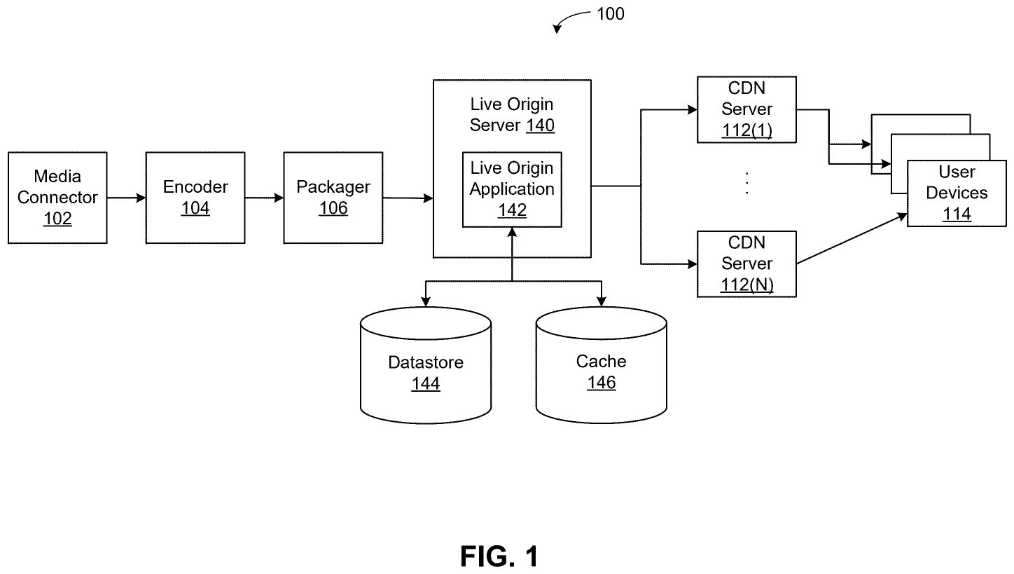

FIG. 1 illustrates a block diagram of a computer-based system 100 configured to implement one or more aspects of the various embodiments. As shown, system 100 includes, without limitation, a media connector 102, an encoder 104, a packager 106, a live origin server 140 connected to a datastore 144 and a cache 146, and one or more CDN servers 112 in communication with one or more user devices 114 via a network (not shown), such as the Internet.

Media connector 102 is a system component or interface that receives transmitted data from media sources and live media feeds, terminates the transmission, and extracts video streams from the transmitted data. Media connector 102 can enable the exchange of various types of media, such as video and audio, by supporting different protocols and data formats. Media connector 102 can incorporate hardware and/or software to manage data translation, signal conversion, or protocol adaptation, ensuring appropriate routing of media content across diverse environments.

Encoder 104 is specialized software and/or hardware designed to convert digital content into a suitable format for storage, transmission, and/or display. Encoder 104 can process various types of content, such as audio and/or video, by applying compression algorithms and encoding schemes to transform raw data content into one or more optimized, standardized formats. Encoder 104 can support multiple encoding standards and codecs to accommodate different content types and delivery platforms. For example, encoder 104 can perform video transcoding and generate different audio/video bit rates and segments encoded media (e.g., video, audio, and/or text) to small chunks for live distribution.

Packager 106 is a publishing server that can create, manage, and distribute digital content across a network. Packager 106 can manage the workflow for content updates, ensuring that content is properly prepared and formatted for dissemination. Packager 106 can include any software for content management, authentication, and distribution automation. For example, packager 106 can take the encoded chunks from encoder 104 and perform digital rights management (DRM) encryption, then transmit the encrypted chunks to live origin server 140.

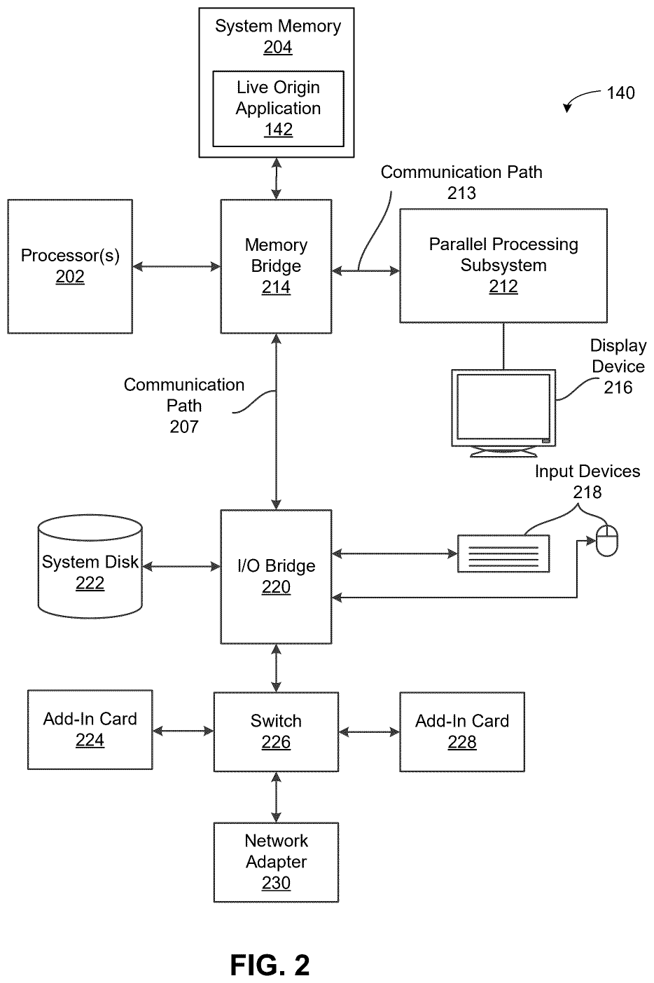

Live origin server 140 is a server that can be used to transmit media content items (e.g., video and/or audio) and related metadata to client applications that play back the media content items. In some embodiments, live origin server 140 receives packaged media content items for distribution from packager 106, and live origin server 140 is considered the source of truth for the media content items. Illustratively, live origin server 140 includes, without limitation, a live origin application 142. Live origin application 142 can be stored in a memory, and execute on one or more processors of, live origin server 140, as discussed in greater detail below in conjunction with FIG. 2.

Live origin application 142 can receive and process requests from packager 110 to write media content item data and/or associated manifest information (also referred to herein as “write requests”) to storage, shown as datastore 144 and cache 146. Live origin application 142 can also receive and process requests for media content item data and/or manifest information (also referred to herein as “read requests”) from client applications running on user devices 114.

Datastore 144 provides non-volatile storage for applications and data in live origin server 140. For example, and without limitation, media content item segments (also referred to herein as “segments”), manifest information, and/or associated metadata can be stored in datastore 144. In some embodiments, datastore 144 can include one or more fixed or removable hard disk drives, flash memory devices, CD-ROMs (compact disc read-only-memories), DVD-ROMs (digital versatile disc-ROMs), Blu-rays, HD-DVDs (high definition DVDs), and/or other magnetic, optical, or solid state storage devices. In some embodiments, datastore 144 can be a network attached storage (NAS) and/or a storage area-network (SAN). Although shown as coupled to live origin server 140, in various embodiments, live origin server 140 can include datastore 144.

Cache 146 provides non-volatile and/or volatile storage for applications and data in live origin server 140. For example, and without limitation, the segments can be stored in cache 146. In some embodiments, cache 146 can include one or more random access memories (RAMs), fixed or removable hard disk drives, flash memory devices, CD-ROMs (compact disc read-only-memories), DVD-ROMs (digital versatile disc-ROMs), Blu-rays, HD-DVDs (high definition DVDs), and/or other magnetic, optical, or solid state storage devices. datastore 144 can be a network attached storage (NAS) and/or a storage area-network (SAN). In some embodiments, cache 146 can be an ephemeral volatile (EV) cache that includes memory and one or more ephemeral disks. Although shown as coupled to live origin server 140, in various embodiments, live origin server 140 can include cache 146.

CDN servers 112 include one or more specialized computing devices designed to efficiently deliver media content, such as the segments, to client applications. CDN servers 112 can be geographically distributed to minimize the distance media content travels when being delivered to clients, such as user devices 114. CDN servers 112 can be positioned at the edge of a network, closer to clients. CDN servers 112 can also act as intermediaries between clients and live origin server 140 by requesting media content from live origin server 140 when such media content is not available in CDN servers 112 cache. In some embodiments, CDN servers 112 can distribute incoming traffic among multiple servers to optimize resource use, avoid overload, and increase performance.

User devices 114 are electronic devices that individuals utilize to interact with digital content or services over a network. User devices 114 can include, but are not limited to, personal computers, laptops, smartphones, tablets, smart TVs, gaming consoles, and/or wearable devices such as smartphones with an application to stream media content. Client applications (not shown) running on user devices 114 can connect to and communicate with CDN servers 112 or other network components to access, consume and manipulate content or engage in various digital activities, such as streaming media content. User devices 114 can include processors, memory, communication interfaces, and user interfaces.

System 100 shown herein is for illustrative purposes only, and variations and modifications are possible without departing from the scope of the present disclosure. For example, the number and types of servers, and/or the number of user devices can be modified as desired. Further, the connection topology between the various units in FIG. 1 can be modified as desired. In some embodiments, any combination of the server(s) and/or user devices can be included in and/or replaced with any type of virtual computing system, distributed computing system, and/or cloud computing environment, such as a public, private, or a hybrid cloud system.

FIG. 2 is a more detailed illustration of live origin server 140 of FIG. 1, according to the various embodiments. Live origin server 140 may be any type of computing device, including, without limitation, a server machine, a server platform, a desktop machine, a laptop machine, a hand-held/mobile device, a digital kiosk, an in-vehicle infotainment system, and/or a wearable device. In some embodiments, live origin server 140 is a server machine operating in a data center or a cloud computing environment that provides scalable computing resources as a service over a network.

As shown, the live origin server 140 includes, without limitation, processor(s) 202 and system memory(ies) 204 coupled to a parallel processing subsystem 212 via a memory bridge 214 and a communication path 213. Memory bridge 214 is further coupled to an I/O (input/output) bridge 220 via a communication path 207, and I/O bridge 220 is, in turn, coupled to a switch 226.

In various embodiments, I/O bridge 220 is configured to receive user input information from optional input devices 218, such as a keyboard, mouse, touch screen, sensor data analysis (e.g., evaluating gestures, speech, or other information about one or more uses in a field of view or sensory field of one or more sensors), and/or the like, and forward the input information to the processor(s) 202 for processing. In some embodiments, live origin server 140 may be a server machine in a cloud computing environment. In such embodiments, live origin server 140 may not include input devices 218, but may receive equivalent input information by receiving commands (e.g., responsive to one or more inputs from a remote computing device) in the form of messages transmitted over a network and received via the network adapter 230. In some embodiments, switch 226 is configured to provide connections between I/O bridge 220 and other components of live origin server 140, such as a network adapter 230 and various add-in cards 224 and 228.

In some embodiments, I/O bridge 220 is coupled to a system disk 222 that may be configured to store content and applications and data for use by processor(s) 202 and parallel processing subsystem 212. In one embodiment, system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 220 as well.

In various embodiments, memory bridge 214 may be a Northbridge chip, and I/O bridge 220 may be a Southbridge chip. In addition, communication paths 207 and 213, as well as other communication paths within live origin server 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 216 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. Memory 204 includes at least one device driver configured to manage the processing operations of the one or more PPUs within parallel processing subsystem 212. Illustratively, memory 204 includes, without limitation, live origin application 146.

In various embodiments, parallel processing subsystem 212 may be integrated with one or more of the other elements of FIG. 2 to form a single system. For example, parallel processing subsystem 212 may be integrated with processor 202 and other connection circuitry on a single chip to form a system on a chip (SoC).

In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 204 could be connected to the processor(s) 202 directly rather than through memory bridge 214, and other devices may communicate with system memory 204 via memory bridge 214 and processor 202. In other embodiments, parallel processing subsystem 212 may be connected to I/O bridge 220 or directly to processor 202, rather than to memory bridge 214. In still other embodiments, I/O bridge 220 and memory bridge 214 may be integrated into a single chip instead of existing as one or more discrete devices. In certain embodiments, one or more components shown in FIG. 2 may not be present. For example, switch 226 could be eliminated, and network adapter 230 and add-in cards 224, 228 would connect directly to I/O bridge 220. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Optimized Storage Utilization in Live Origin Servers

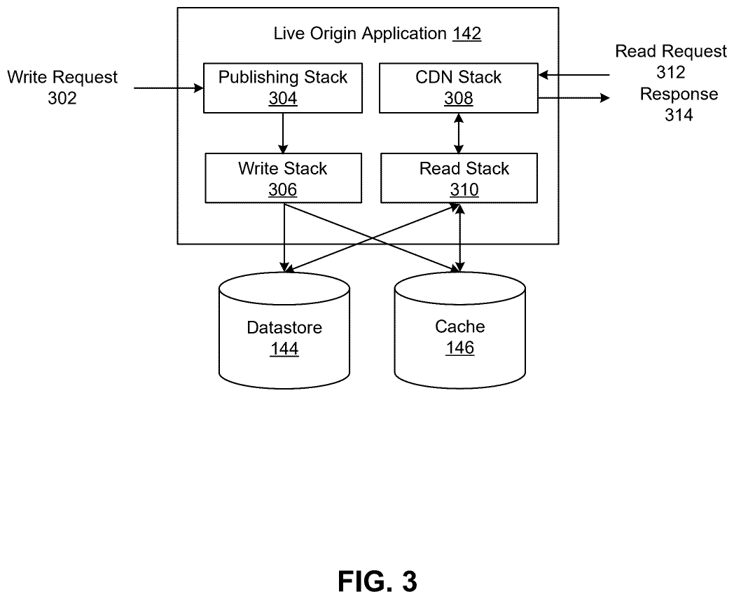

FIG. 3 is a more detailed illustration of live origin application 142 of FIG. 1, according to various embodiments. As shown, live origin application 142 includes a publishing stack 304, a write stack 306, a CDN stack 308, and a read stack 310. In operation, live origin application 142 can receive write requests, shown as a write request 302, and read requests, shown as a read request 312. In response to receiving write request 302, live origin application 142 writes media content item data included in write request 302 to datastore 144 and cache 146. In response to receiving read request 312, live origin application 142 returns data, such as a media content item segment or manifest information, that is being requested to a client application that made read request 312.

Write request 302 is a request from packager 106 to write a segment of a media content item and/or manifest information to live origin application 142. For example, write request 302 can request to write the segment related to a live stream or digital video recorder (DVR) media content item. As another example, write request 302 can request to write manifest information specifying the segments and/or version of a media content item. In some embodiments, write request 302 includes information that indicates data therein is mutable or immutable, information that indicates the data is from a restarted live stream event, and/or information that indicates the data is originated from a different substream of a live stream. As used herein, a substream of a media content item refers to video or audio of the media content item that has been encoded at a particular bitrate and/or resolution on, e.g., a bitrate ladder that permits a client application to choose an encoded video substream and an encoded audio substream best suited for a network condition experienced by the client application. Any number of video and/or audio substreams can be encoded for a given media content item. In some embodiments, a uniform resource locator (URL) of write request 302 can specify that write request 302 includes either (1) media content data (e.g., a media content item segment), which is immutable data that is not modified; or (2) manifest information, which is mutable data that can be modified and updated with newer versions. In some embodiments, a suffix of the URL can indicate the data of a write request is media content data or manifest information. In some embodiments, different substream identifiers (IDs) can be assigned to data write requests from different substreams, including substreams of restarted live streams.

Publishing stack 304 receives write request 302 from packager 106 and sends a request to write stack 306 to write data from write request 302 to datastore 144 and/or cache 146. Assuming write request 302 includes a media content item segment, publishing stack 304 can associate any suitable metadata, such as metadata indicating a unique segment ID, segment arrival time, segment size, whether the segment is last segment, key, substream ID, and/or segment duration, with the segment in write request 302. In addition, in some embodiments, publishing stack 304 determines whether write request 302 includes mutable or immutable data by parsing the URL of write request 302. In some other embodiments, publishing stack 304 can determine whether write request 302 includes mutable or immutable data in any technically feasible manner, such as by inspecting the data included in write request 302. Publishing stack 304 tags the data of write request 302 as being mutable or immutable according to the determination. The data of write request 302 can be tagged in any technically feasible manner, such as by associating metadata with the data of write request 302 that indicates the determined mutability or immutability of the data. Selective consistency support is implemented in which consistency is only verified for mutable data to avoid the unnecessary overhead of verifying consistency of immutable data, which can reduce latency when reading immutable data, especially as immutable data such as media content item segments can be larger than mutable data such as manifest information. Because the immutable data does not change, the immutable data can also be cached in cache 146, without having to clear cache 146 when writes occur because the immutable data does not change. Storing immutable data in cache 146 can further reduce latency when reading the immutable data from cache 146, which is faster than reading the immutable data from datastore 144. In addition, background processes to delete outdated versions of data do not need to operate on immutable data whose version does not change, which further reduces computational overhead.

In some embodiments, publishing stack 304 also determines if write request 302 is associated with a restarted live stream event. In such cases, publishing stack 304 can read configuration information corresponding to a write request 302 and add different data segment IDs and keys to differentiate segments for a restarted live stream event from segments for the live stream event before restarting. Publishing stack 304 then requests that write stack 306 write the segment or manifest information from write request 302 along with associated metadata, which can include the segment ID, a segment arrival time, key, substream ID, segment duration, etc. to datastore 144 and/or cache 146.

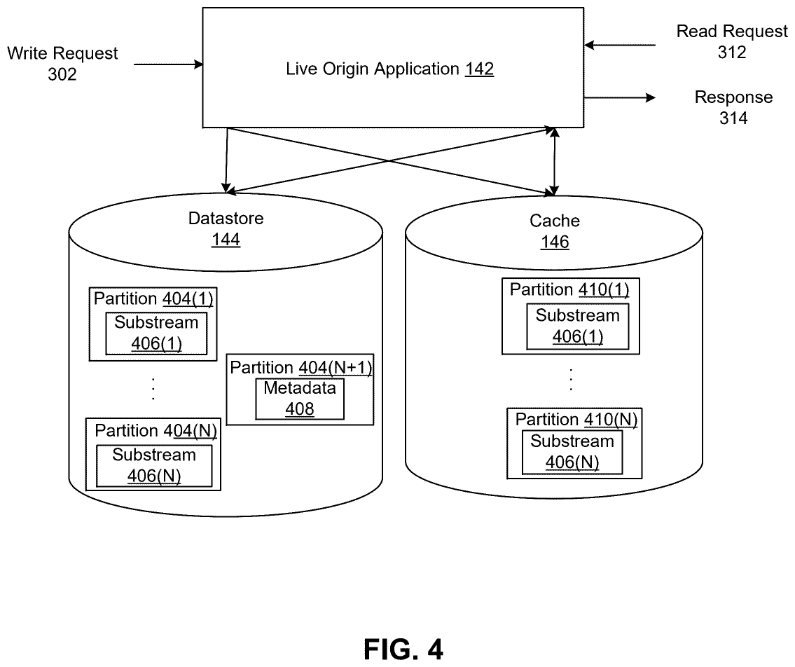

Write stack 306 reads metadata corresponding to the data (e.g., a media content item segment or manifest information) being written and, if the metadata shows the data is mutable data, write stack 306 writes the data and corresponding metadata to datastore 144. In some embodiments, write stack 306 writes mutable manifest information into a partition in datastore 144, discussed in greater detail below in conjunction with FIG. 4.

On the other hand, if the metadata corresponding to the data being written shows the data is immutable data, such as a media content item segment, write stack 306 writes the data and corresponding metadata to datastore 144 and cache 146. Although described primarily herein with respect to writing media content item segments, in some embodiments, write stack 306 can break media content item segments into chunks (e.g., 512 Mb chunks) and write the chunks to datastore 144 and cache 146. In some embodiments, write stack 306 uses the metadata, such as a substream ID and/or key, to write a segment into a partition associated with the substream ID within datastore 144 and cache 146, as discussed in greater detail below in conjunction with FIG. 4. In some embodiments, cache 146 can be an ephemeral volatile (EV) cache that uses memory and one or more ephemeral disks to store data, such as the segments. In some embodiments, each media content item segment written to datastore 144 and cache 146 is addressable using corresponding metadata written to datastore 144.

Read request 312 is a request for a media content item segment or manifest information from live origin application 142. For example, read request 312 can request, from live origin application 142, a segment of a live streaming media content item or a DVR media content item having a particular ID. CDN stack 308 receives read request 312. For a read request 312 that requests manifest information, which is mutable, CDN stack 308 requests that read stack 310 read the manifest information from datastore 144. For a read request 312 that requests a media content item segment, which is immutable, CDN stack 308 reads a configuration file associated with the segment to obtain the arrival time of a first segment of the media content item, a segment number of a first content item segment, and a frequency of the segments. CDN stack 308 retrieves, from datastore 144, metadata related to the requested segment using read stack 310, and CDN stack 308 requests, via read stack 310, the segment from cache 146 based on the metadata. For example, the metadata could indicate chunks of the segment and starting and endings of those chunks, which can be used to retrieve those chunks from cache 146 or datastore 144. Cache 146 can return the segment to the read stack 310 if the segment is stored in cache 146. On the other hand, if the metadata indicates that the segment has been updated in the datastore 144, then read stack 310 will read the segment from the datastore 144 instead. Accordingly, CDN stack 308 ensures write/read consistency by providing the most updated media content item segments.

FIG. 4 is a more detailed illustration of partitions in which live origin application 142 of FIG. 1 can store data, according to various embodiments. As shown, datastore 144 includes partitions 404(1)-(N) that store substreams 406(1)-(N) of media content items, as well as a partition 404(N+1), which stores metadata 408. Metadata 408 includes metadata for each substream 406(1)-(N), i.e., there are N metadata, one for each substream. Cache 146 also includes partitions 404(1)-(N) that store substreams 406(1)-(N). One partition per substream is created in each of datastore 144 and cache 146. In some embodiments, each partition is a unit of data storage that is identified by a partition key (e.g., a hash key). Each partition defines how associated data is distributed across the nodes of datastore 144 or cache 146. All items with the same partition key can be stored together on a node or set of nodes that can be determined consistently using the partition key. Each item in a partition can also be sorted based on a clustering key (sort key) of the item.

In operation, live origin application 142 can receive write and read requests, shown as a write request 302 and a read request 312, similar to the description above in conjunction with FIG. 3. Live origin application 142 writes data from write request 302 in datastore and/or cache 146. Live origin application 142 returns a response 314 to read request 312 from datastore 144 and/or cache 146.

As described above in conjunction with FIG. 3, publishing stack 304 tags data from write request 302 as being mutable or immutable. If the data is tagged as being mutable, write stack 306 writes the data and corresponding metadata to datastore 144 and cache 146. In some embodiments, write stack 306 uses substream IDs to write media content item segments associated with different substream IDs in different partitions within datastore 144 and cache 146. Illustratively, substreams 406(1) to 406(N) are stored in partitions 404(1) to 404(N), respectively, across datastore 144 and cache 146. In addition, metadata 408 corresponding to media content item segments is stored in a partition 404(N+1). As described, metadata 408 includes metadata for each substream 406(1)-(N), i.e., there are N metadata, one for each substream. Although described herein primarily with respect to storing media content item segments in partitions, other data, such as manifest information, can also be stored in one or more partitions in some embodiments.

In some embodiments, the partition 404(1)-(N+1) in which data is stored can be specified in metadata 408. Each partition 404(1)-(N) can store data across multiple servers within datastore 144 and cache 146, and partition 404(N+1) can store data across multiple servers within datastore 144. By storing different substreams in separate partitions and spreading out the substream data across servers of the partitions so that the servers are relatively evenly loaded, network jitter, which is the variation in latency, during streaming of substreams can be reduced while also maximizing throughput. In some embodiments, write stack 306 assigns different substream IDs and keys to substreams of a restarted live stream event, which are then stored in different partitions from substreams of the live stream event before restarting. For example, a different substream ID can be assigned that adds a random value to an existing substream ID. Modifying the substream IDs for a restarted live stream ensures that those substreams are stored in different partitions whose data is not deleted when data for the previous live stream event that is stored in previously created partitions are deleted.

On the other hand, if the data being written is tagged as being mutable data, such as manifest information, write stack 306 writes the data and corresponding metadata to datastore 144. For example, write stack 306 could write mutable manifest information to a separate partition within datastore 144.

Read request 312 is a request for a segment of a media content item or manifest information from live origin application 142. For example, read request 312 could request, from live origin application 142, a segment of a live streaming media content item. In response to read request 312, live origin application 142 returns a media content item or portion thereof, such as a segment, that is being requested to a client application that made read request 312. After receiving read request 312, live origin application 142 (specifically, read stack 310 of live origin application 142) transmits read request 312 for processing by a server associated with one of partitions 404(1)-(N) that stores the segment in datastore 144 or cache 146. Live origin application 142 then monitors the elapsed time for the request. In some embodiments, if the elapsed time is below a threshold, live origin application 142 returns a response from the server to the client application that made read request 312. In such cases, the threshold can be an average response time or a predefined time (e.g., 500 milliseconds). On the other hand, if the elapsed time for read request 312 is above the threshold, live origin application 142 performs a “hedging” technique in which live origin application 142 (specifically, read stack 310) transmits read request 312 to one or more other servers to be processed. For example, in some embodiments, live origin application 142 transmits another, speculative read request, which may go to another server for processing. Any number of additional speculative requests can also be transmitted if the elapsed time for previous read requests continues to be longer than the expected amount of time. In some embodiments, the speculative requests can be transmitted before a maximum timeout, which is a maximum latency that can be tolerated. When a media content item segment is stored in chunks, speculative requests can be made for each chunk when the response time is above the threshold. Then, live origin application 142 returns the fastest response from the servers in response to the original request and the speculative request(s) to the client application. It should be understood that latency can be reduced by returning the fastest response. Although described herein primarily with respect to performing hedging for read requests, in some embodiments, a similar hedging technique can be performed for write requests that exceed an expected response time.

In some embodiments, write stack 306 can, in response to a user request to delete a substream (e.g., an outdated substream associated with a previous live stream event), delete a partition associated with the substream, which can be faster than deleting the media content item segments for the substream that are stored across different servers of datastore 144 and cache 146. In such cases, deleting the partition can include performing a soft delete that makes media content item segments associated with the partition inaccessible, and then deleting data in datastore 144 and cache 146 that are associated with the partition via a background process.

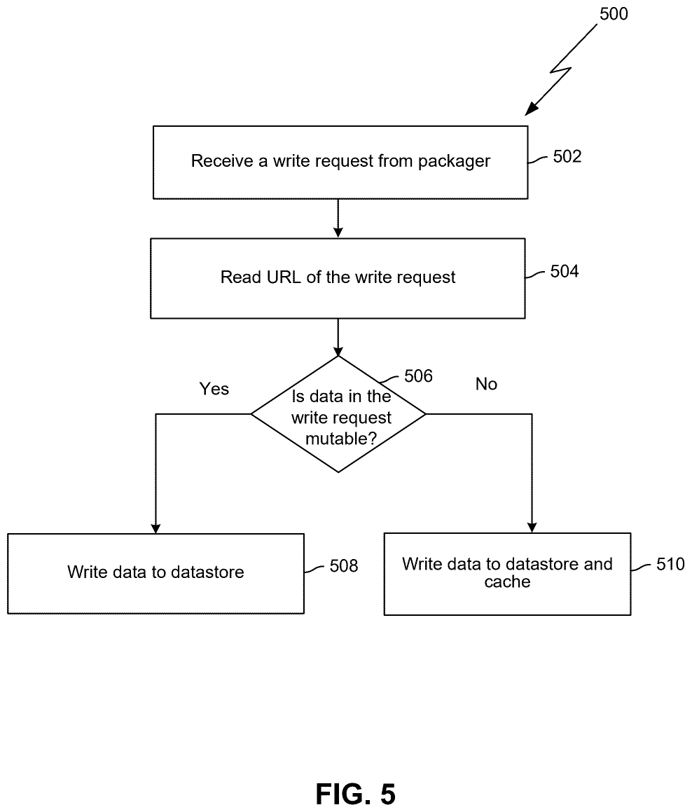

FIG. 5 is a flow diagram of method steps for writing mutable and immutable data, according to various embodiments. Although the method steps are described in conjunction with the systems of FIGS. 1-4, persons skilled in the art will understand that any system configured to perform the method steps in any order falls within the scope of the various embodiments.

As shown, a method 500 begins at step 502, where live origin application 142 receives a write request from packager 106. Write request 302 is a request from packager 106 to write a segment of a media content item and/or manifest information to live origin application 142. For example, write request 302 could request to write a media content item segment related to a live stream or DVR media content. As another example, write request 302 could request to write manifest information specifying the segments and/or version of a media content item.

At step 504, publishing stack 304 reads a URL of write request 302. The URL of write request 302 can specify that write request 302 includes either (1) media content data (e.g., a media content item segment), which is immutable data that cannot change; or (2) manifest information, which is mutable data that can change. In some embodiments, a suffix of the URL can indicate the media content data or manifest information.

At step 506, publishing stack 304 determines whether write request 302 includes mutable or immutable data by parsing the URL of write request 302. In some other embodiments, publishing stack 304 can determine whether write request 302 includes mutable or immutable data in any technically feasible manner, such as by inspecting the data included in write request 302. Publishing stack 304 tags the data of write request 302 as being mutable or immutable according to the determination at step 506. Publishing stack 304 can tag the data of write request 302 in any technically feasible manner, such as by associating metadata with the data of write request 302 that indicates the determined mutability or immutability. Downstream components of live origin server 140, such as write stack 306, can then use the tag when processing the data of write request 302.

If publishing stack 304 determines that write request 302 includes mutable data, then method 500 continues to step 508, where write stack 306 writes the mutable data to datastore 144. The mutable data can include manifest information that can change and be updated. Write stack 306 can also write metadata corresponding to the mutable data to datastore 144. In some embodiments, based on a tag indicating that the data is mutable, write stack 306 writes the data into one or more partitions in datastore 144, as discussed above in conjunction with FIG. 4.

On the other hand, if publishing stack 304 determines that write request 302 includes immutable data, then method 500 continues to step 510, where write stack 306 writes the immutable data to datastore 144 and cache 146. The immutable data can include a media content item segment that is not changed once written. Write stack 306 can also write metadata corresponding to the immutable data to datastore 144. In some embodiments, write stack 306 uses the metadata, such as a substream ID and/or key, to write a media content item segment in its own partition within datastore 144 and cache 146, as discussed above in conjunction with FIG. 4.

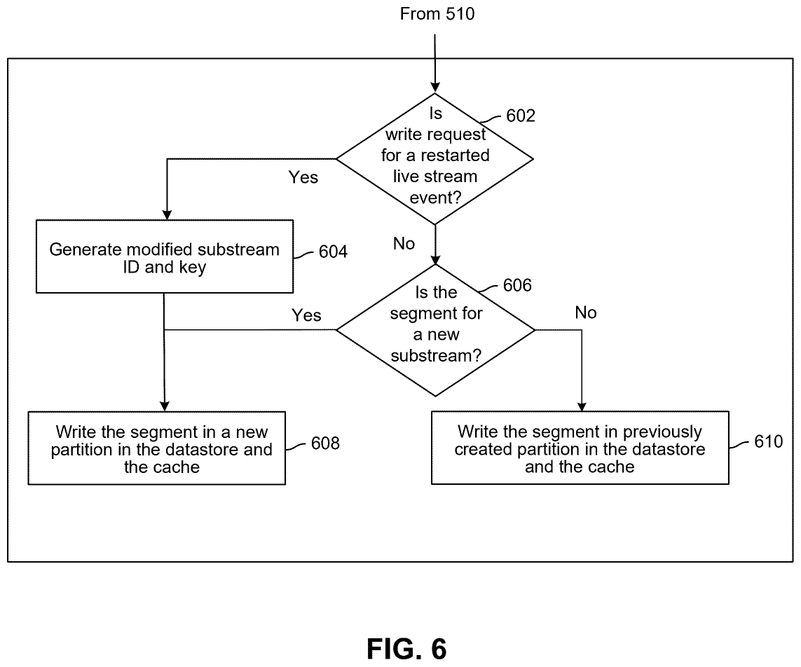

FIG. 6 is a flow diagram of method steps for writing immutable data, according to various embodiments. Although the method steps are described in conjunction with the systems of FIGS. 1-4, persons skilled in the art will understand that any system configured to perform the method steps in any order falls within the scope of the various embodiments.

As shown, at step 602, publishing stack 304 determines if write request 302 is associated with a restarted live stream event. In some embodiments, updated event configuration data can indicate if an event is a restarted live stream event.

If publishing stack 304 determines that write request 302 is associated with a restarted live stream event, then at step 604, publishing stack 304 generates a modified media content item segment ID and key. Publishing stack 304 reads configuration information corresponding to write request 302 and assigns, to a media content item segment in write request 302, a different data segment ID and key to differentiate the segment for the restarted live stream event from a segment for the live stream event before restarting. For example, in some embodiments, publishing stack 304 can add a random value to a previous segment ID to generate a different data segment ID.

On the other hand, if publishing stack 304 determines that write request 302 is not associated with a restarted live stream event, then method 600 continues to step 606, where publishing stack 304 determines whether a media content item segment being written is for a new substream. Write request 302 can include information in, for example, a URL of write request 302 that indicates data being written is for a new substream. In some embodiments, a substream ID can be assigned to a media content item segment in write request 302 that is for a new substream.

If publishing stack 304 determines that the media content item segment being written is for a new substream, then method 600 continues to step 608, where write stack 306 writes the segment in a new partition in the datastore 144 and cache 146. As described above in conjunction with FIG. 4, in some embodiments, write stack 306 uses a substream ID and/or key to write a corresponding segment in a separate partition within each of datastore 144 and cache 146, such as one of partitions 404(1)-(N) within datastore 144 and cache 146. In addition, write stack 306 writes metadata corresponding to the segment to partition 404(N+1). In some embodiments, each segment written to datastore 144 and cache 146 is addressable using corresponding metadata written to datastore 144.

On the other hand, if publishing stack 304 determines that the media content item segment being written is not for a new substream, then method 600 continues to step 610, where write stack 306 writes the segment to a previously created partition for an existing substream in datastore 144 and cache 146. In some embodiments, each segment written to cache 146 is addressable using corresponding metadata written to datastore 144.

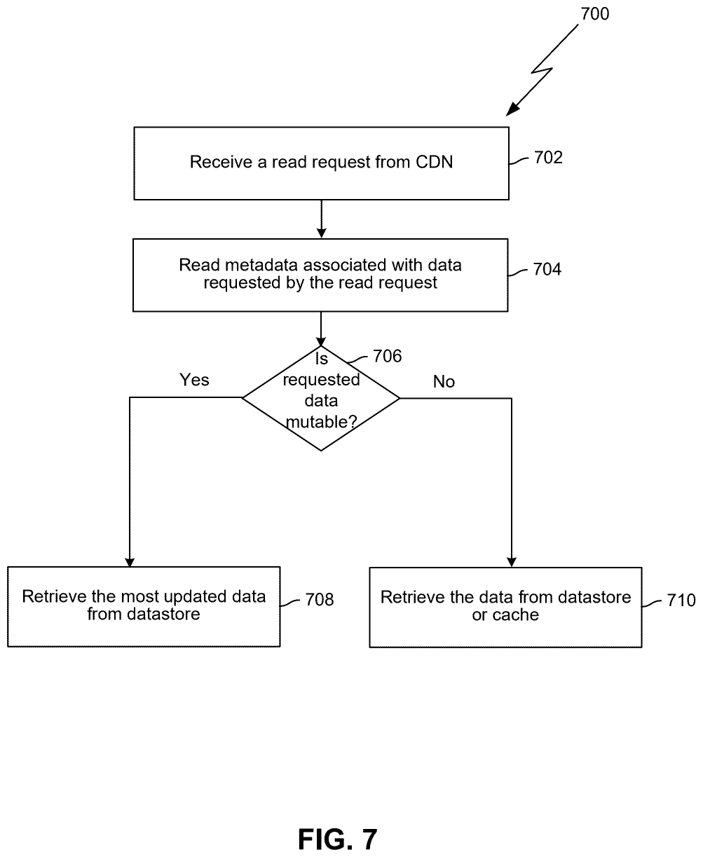

FIG. 7 is a flow diagram of method steps for responding to a read request, according to various embodiments. Although the method steps are described in conjunction with the systems of FIGS. 1-4, persons skilled in the art will understand that any system configured to perform the method steps in any order falls within the scope of the various embodiments.

As shown, a method 700 begins at step 702, where CDN stack 308 receives a read request 312 from CDN server 112. Read request 312 is a request for a media content item segment or manifest information from live origin application 142. For example, read request 312 can request, from live origin application 142, a segment of a live streaming media content item or a DVR media content item having a particular ID. As another example, read request 312 can request, from live origin application 142, manifest information

At step 704, CDN stack 308 reads, from datastore 144, metadata associated with data requested by read request 312. In some embodiments, the metadata can point to where the requested data is stored in datastore 144 and/or cache 146. In such cases, CDN stack 308 can search for the data associated with the read request using the metadata.

At step 706, CDN stack 308 determines whether the requested data is mutable. In some embodiments, CDN stack 308 can determine whether the requested data is mutable or immutable based on the type of data being requested. For example, manifest information can be mutable data that can be updated/changed, whereas media content item segments can be immutable data that is not changed.

If CDN stack 308 determines that the requested segment is mutable, then at step 708, where CDN stack 308 retrieves the most updated data from datastore 144. For a read request 312 that requests manifest information that is mutable, CDN stack 308 requests that read stack 310 read the manifest information from datastore 144. Read stack 310 reads, from datastore 144, the requested manifest information, which CDN stack 308 can then return to a client application that made read request 312.

On the other hand, if CDN stack 308 determines that the requested segment is immutable, then method 700 continues to step 710, where CDN stack 308 retrieves the segment from datastore 144 or cache 146. For a read request 312 that requests an immutable segment, CDN stack 308 reads a configuration file associated with the segment to obtain the arrival time of a first segment of the media content item, a segment number of a first media content item segment, and a frequency of content media segments. CDN stack 308 retrieves, from datastore 144 and via read stack 310, metadata related to the requested segment, and CDN stack 308 requests, via read stack 310, the segment from cache 146 based on the metadata. Cache 146 can return the segment to the read stack 310 if the segment is stored in cache 146. If the segment is not stored in cache 146, then CDN stack 308 can request, via read stack 310, the segment from datastore 144. CDN stack 308 then returns the read segment to a client application that made request 312. The read segment can also be cached by CDN servers 112 for use in responding to future read requests.

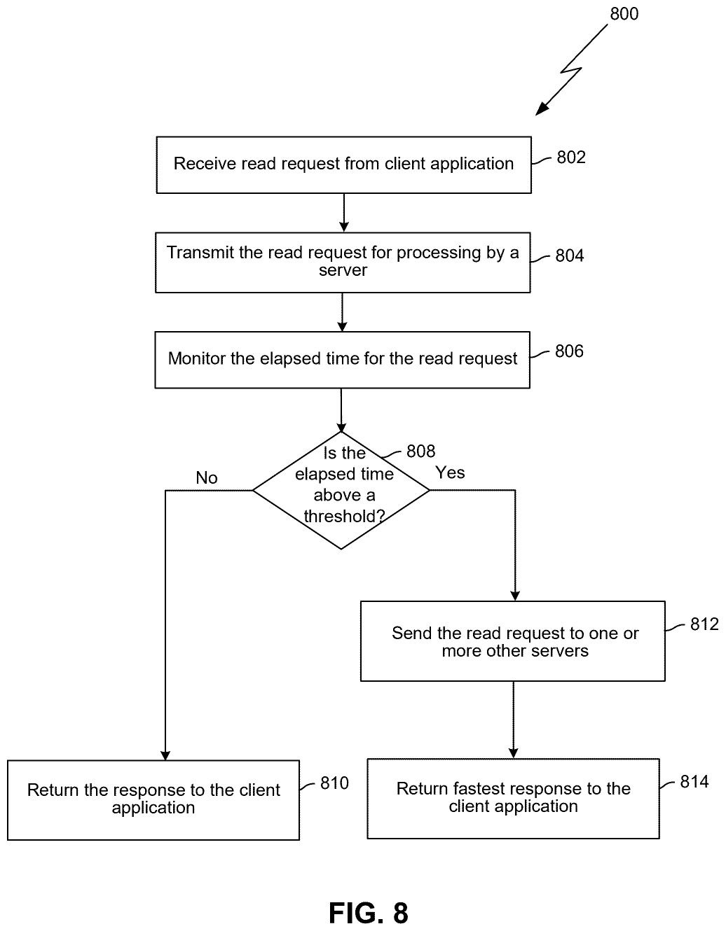

FIG. 8 is a flow diagram of method steps for a hedging during processing of a read request, according to various embodiments. Although the method steps are described in conjunction with the systems of FIGS. 1-4, persons skilled in the art will understand that any system configured to perform the method steps in any order falls within the scope of the various embodiments.

As shown, a method 800 begins at step 802, where live origin application 142 receives a read request 312 from a client application. As described above in conjunction with FIG. 4, read request 312 is a request for a segment of a media content item or manifest information from live origin application 142.

At step 804, live origin application 142 transmits read request 312 for processing by a server. After receiving read request 312, live origin application 142 (specifically, read stack 310 of live origin application 142) transmits read request 312 for processing by a server associated with one of partitions 404(1)-(N) that stores the data in datastore 144 and cache 146. Whether cache 146 or datastore 144 is used depends on whether the requested datastore has been cached in cache 146, which is indicated by metadata in datastore 144.

At step 806, live origin application 142 monitors the elapsed time for the read request 312 transmitted at step 804. At step 808, live origin application 142 determines whether the response time is above a threshold. In some embodiments, the threshold can be an average response time from servers in datastore 144 or cache 146. In some embodiments, the threshold can be a set time duration, such as 500 milliseconds.

If live origin application 142 determines that the elapsed time is not above the threshold, then at step 810, live origin application 142 returns response 314 to the client application. Live origin application 142 returns response 314 from a server associated with one of partitions 404(1)-(N) that stores the requested data in datastore 144 or cache 146 to the client application that made read request 312.

On the other hand, if live origin application 142 determines that the elapsed time is above the threshold, method 800 continues to step 812, where live origin application 142 sends read request 312 to one or more other servers associated with one of partitions 404(1)-(N) that stores the requested data in datastore 144 or cache 146. That is, live origin application 142 performs a “hedging” technique in which live origin application 142 (specifically, read stack 310) transmits read request 312 to one or more other servers before receiving a response from a first server to which read request 312 was also transmitted.

At step 814, live origin application 142 returns the fastest response to the client application. Read stack 310 monitors responses from the servers to which read request 312 was transmitted and returns a response 314 to the client application as soon as any of the processing servers responds.

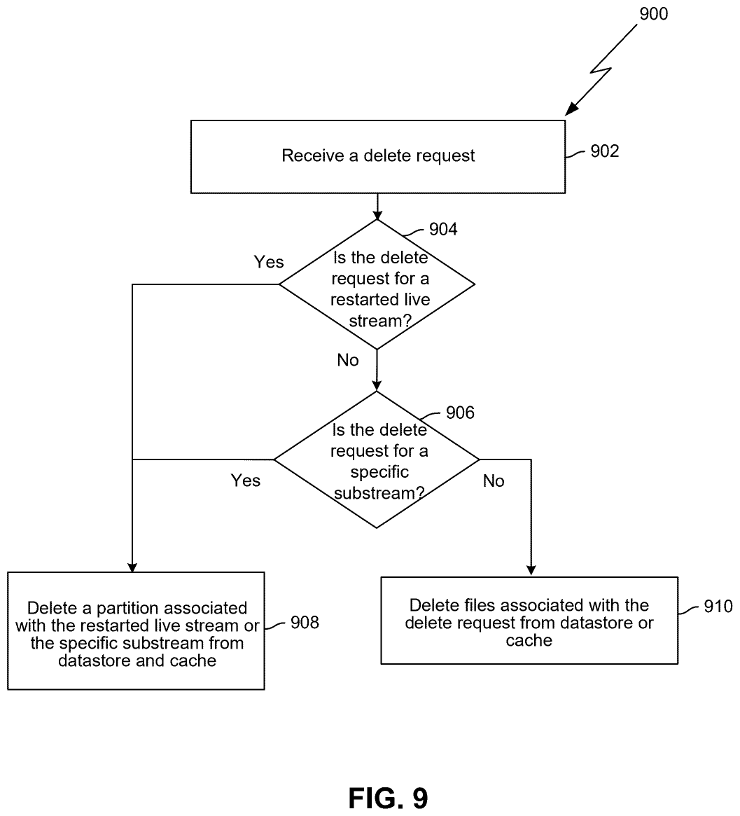

FIG. 9 is a flow diagram of method steps for processing a deletion request, according to various embodiments. Although the method steps are described in conjunction with the systems of FIGS. 1-4, persons skilled in the art will understand that any system configured to perform the method steps in any order falls within the scope of the various embodiments.

As shown, a method 900 begins at step 902, where live origin application 142 receives a delete request. In some embodiments, the delete request can be made by a user. For example, a user could request to delete a substream associated with an outdated live stream event.

At step 904, live origin application 142 determines whether the delete request is for a restarted live stream. In some embodiments, write stack 306 determines whether the delete request is for a restarted live stream by reading metadata corresponding to a segment in a separate partition within each of datastore 144 and cache 146, such as one of partitions 404(1)-(N) within datastore 144 and in cache 146.

If live origin application 142 determines that the delete request is not for a restarted live stream, then at step 906, live origin application 142 determines whether the delete request is for a specific substream. In some embodiments, write stack 306 uses a substream ID in metadata 408 to determine a specific substream corresponding to a media content item segment stored in a separate partition within each of datastore 144 and cache 146, such as one of partitions 404(1)-(N) within datastore 144 and cache 146.

If live origin application 142 determines that the delete request is for a restarted live stream or a specific substream, then at step 908, live origin application 142 deletes a partition associated with the restarted live stream or the specific substream in datastore 144 and cache 146. Write stack 306 can delete a whole partition from partitions 404(1)-(N) in datastore 144 and in cache 146 that stores the media content item segment. In some embodiments, deleting a partition can include performing a soft delete that makes media content item segments associated with the partition inaccessible, and then deleting files associated with the substream in the background.

On the other hand, if live origin application 142 determines that the delete request is not for a specific substream, then method 900 continues to step 910, where live origin application 142 deletes files associated with the delete request from datastore 144 or cache 146.

### Multi-cloud Region Aware Live Origin Servers

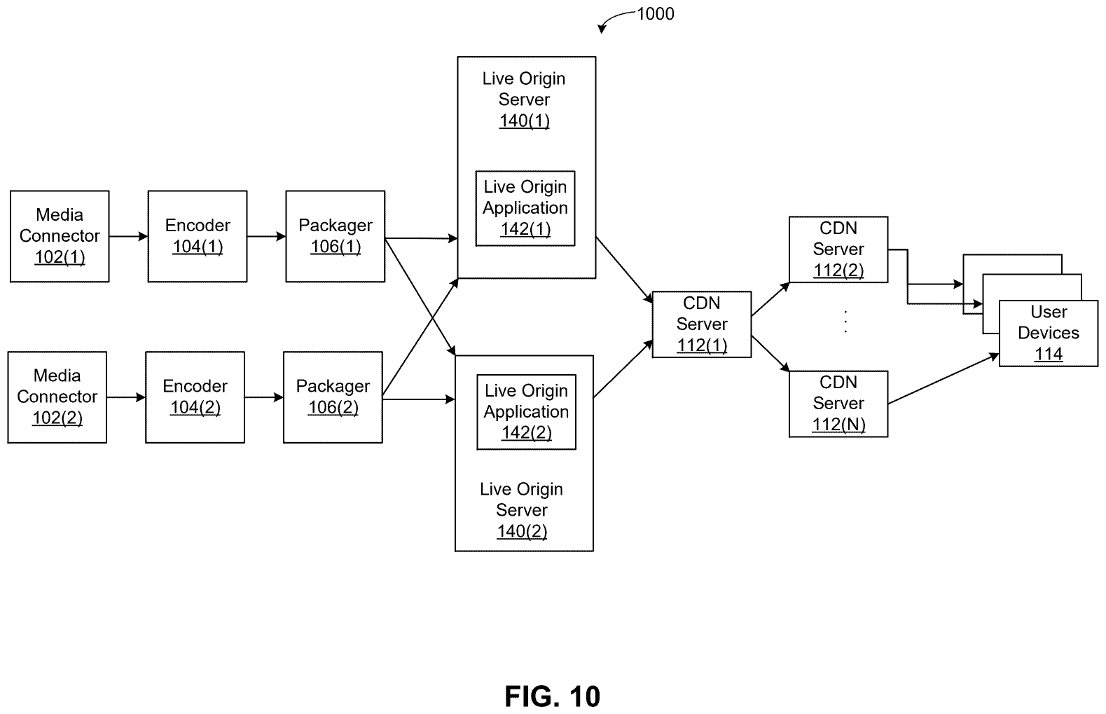

FIG. 10 illustrates live origin servers in two cloud regions, according to various embodiments. Although two cloud regions are shown for illustrative purposes, any number of cloud regions can be used in some embodiments. As shown, a system 1000 includes, without limitation, media connectors 102(1)-(2), encoders 104(1)-(2), packagers 106(1)-(2), live origin servers 140(1)-(2) in different cloud regions, live origin applications 142(1)-(2) (referred to herein collectively as live origin applications 142 and individually as a live origin application 142), and one or more CDN servers 112(1)-(N) in communication with one or more client devices 114 via a network (not shown), such as the Internet. A cloud region is a specific geographic area where a cloud service provider has one or more data centers to deliver cloud-based services, such as live streaming services. Media connector 102(1), encoder 104(1), and packager 106(1) form one encoding pipeline that can encode and package media content data. Media connector 102(2), encoder 104(2), and packager 106(2) form another encoding pipeline that can encode and package media content data.

Similar to the description above in conjunction with FIG. 1, each of media connectors 102(1)-(2) is a system component or interface that receives transmitted data from media sources and live media feeds, terminates the transmission, and extracts video streams from the transmitted data. Media connectors 102(1)-(2) can enable the exchange of various types of media, such as video and audio, by supporting different protocols and data formats. Media connectors 102(1)-(2) can incorporate hardware and/or software to manage data translation, signal conversion, or protocol adaptation, ensuring appropriate routing of media content across diverse environments.

Each of encoders 104(1)-(2) is specialized software and/or hardware designed to convert digital content into a suitable format for storage, transmission, and/or display. Encoders 104(1)-(2) can process various types of content, such as audio and/or video, by applying compression algorithms and encoding schemes to transform raw data content into one or more optimized, standardized formats. Encoders 104(1)-(2) can support multiple encoding standards and codecs to accommodate different content types and delivery platforms. For example, encoders 104(1)-(2) can perform video transcoding and generate different audio/video bit rates and segment encoded video to small chunks for live distribution.

Each of packagers 106(1)-(2) is a publishing server that can create, manage, and distribute digital content across a network. Packagers 106(1)-(2) can manage the workflow for content updates, ensuring that content is properly prepared and formatted for dissemination. Packagers 106(1)-(2) can include any software for content management, authentication, and distribution automation. For example, packagers 106(1)-(2) can take the encoded chunks from encoders 104(1)-(2), respectively, and perform digital rights management (DRM) encryption, then transmit the encrypted chunks to live origin server 140(1)-(2).

Each of live origin servers 140(1)-(2) is a server that can be used to transmit media content items (e.g., video and/or audio) and related metadata to client applications that play back the media content items. In some embodiments, live origin server 140(1) can be in one cloud region while live origin server 140(2) can be in a different cloud region, and live origin servers 140(1)-(2) can communicate with each other via a network, such as the Internet. Live origin servers 140(1)-(2) receive packaged media content items for distribution from packagers 106(1)-(2), respectively, and live origin servers 140(1)-(2) are considered the source of truth for the media content items. Each live origin server 140(1)-(2) can receive a write request 302 associated with one of packagers 106(1)-(2) with a unique key for that packager 106(1)-(2).

Live origin applications 142(1)-(2) running in live origin servers 140(1)-(2), respectively, can write the segments and associated metadata to local data stores and/or caches (e.g., datastore 144 and cache 146) in the same cloud region, and write manifest information and associated metadata to the local datastores, similar to the description above in conjunction with FIGS. 3 and 5. Live origin applications 142(1)-(2) can process write requests as described above in conjunction with FIG. 3. In some embodiments, each of live origin applications 142(1)-(2) replicates metadata that indicates, among other things, where media content item segments and manifest information can be retrieved from, and that is stored in the datastore associated with live origin server 140(1)-(2), respectively, to live origin servers in other cloud regions. In such cases, the metadata can also be written to a control plane namespace, as opposed to data associated with the metadata that is in a data plane. For example, live origin application 142(1) in live origin server 140(1) could asynchronously replicate the metadata, which can be similar to metadata 408 described above in conjunction with FIG. 4, stored in the datastore associated with live origin server 140(1) to a datastore associated with live origin server 140(2). Any technically feasible storage replication technique can be used to replicate the metadata in some embodiments. In contrast to the metadata that is asynchronously replicated to every other live origin server, the live origin application running in a live origin server can determine, based on configuration information and by a packager choosing to (or not to) dual publish to live origin servers in different cloud regions, which live origin server(s) among the live origin servers receive a copy of media content item segments (and associated manifest information), which are larger and more expensive to replicate. If a live origin application determines to replicate media content item segments (and associated manifest information) to other cloud region(s), the segments (and associated manifest information) can be replicated asynchronously to the datastore and/or cache in those other cloud region(s), which is in contrast to writing to the local datastore and cache synchronously by replicating data to a local quorum. Replicating the metadata and (optionally) the data can increase availability in case one of the live origin servers or cloud regions goes down. In particular, each live origin application can read media content item data from its own cloud region which is written by a writer in the same cloud region or a replicated write of a writer from another region. In addition, each live origin application only stores media to its own cloud region.

CDN servers 112(1)-(N) (referred to herein collectively as CDN servers 112 and individually as a CDN server 112) include one or more specialized computing devices designed to efficiently deliver media content, such as the segments, to client applications. CDN servers 112 can be geographically distributed to minimize the distance media content travels when being delivered to clients, such as user devices 114. CDN servers 112 can be positioned at the edge of a network, closer to clients. CDN servers 112 can also act as intermediaries between clients and live origin servers 140(1)-(2) by requesting media content from live origin servers 140(1)-(2) when such media content is not cached by CDN servers 112. In some embodiments, CDN servers 112 can distribute incoming traffic among multiple servers to optimize resource use, avoid overload, and increase performance.

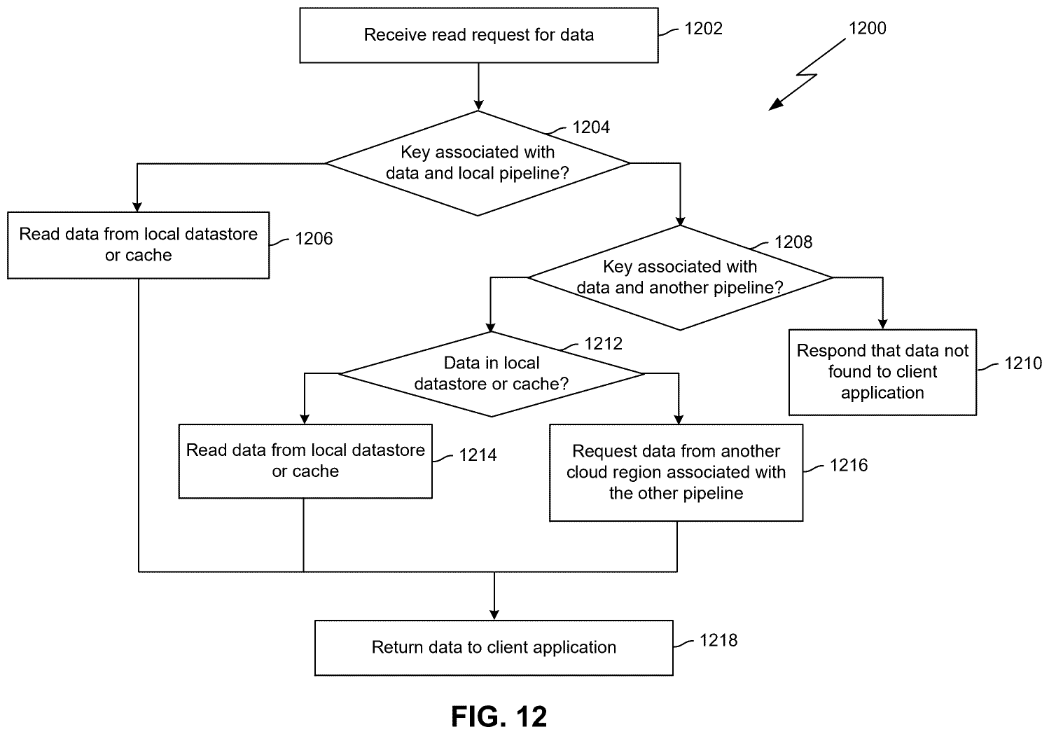

When data is replicated to different cloud regions as described above, a CDN server 112 can request the data from a cloud region having a lowest latency. Further, in response to a read request from a client application that a CDN server 112 is unable to satisfy, that CDN server 112 can forward the read request to a live origin server. If a response is not returned from the live origin server, such as if the live origin server or cloud region is down, the CDN server 112 can transmit the read request to another live origin server in another cloud region where the requested data is replicated, until a response is received. In addition, when metadata is replicated to different cloud regions as described above, a live origin application 142 can check for availability of data from different encoding pipelines (e.g., an encoding pipeline that includes media connector 102(1), encoder 104(1), and packager 106(1) and another encoding pipeline that includes media connector 102(2), encoder 104(2), and packager 106(2)) using keys that are associated with the data and the pipeline. Live origin application 142 can then return data from the pipeline for which the data is available, either from a local datastore or cache or by requesting the data from another live origin application in another cloud region where the data for another encoding pipeline is stored, as discussed in greater detail below in conjunction with FIG. 12. When there is an issue and data needs to be requested from another cloud region, replication of the data to that other cloud region may have caught up even though the replication is asynchronous.

User devices 114 are electronic devices that individuals utilize to interact with digital content or services over a network. User devices 114 can include, but are not limited to, personal computers, laptops, smartphones, tablets, smart TVs, gaming consoles, and/or wearable devices such as smartphones with an application to stream media content. Client applications (not shown) running on user devices 114 can connect to and communicate with CDN servers 112 or other network components to access, consume and manipulate content or engage in various digital activities, such as streaming media content. Client devices 112 can include processors, memory, communication interfaces, and user interfaces.

System 1000 is shown herein, is for illustrative purposes only, and variations and modifications are possible without departing from the scope of the present disclosure. For example, the number and types of servers and regions, and/or the number of user devices can be modified as desired. Further, the connection topology between the various units in FIG. 10 can be modified as desired. In some embodiments, any combination of the server(s) and/or user devices can be included in and/or replaced with any type of virtual computing system, distributed computing system, and/or cloud computing environment, such as a public, private, or a hybrid cloud system.

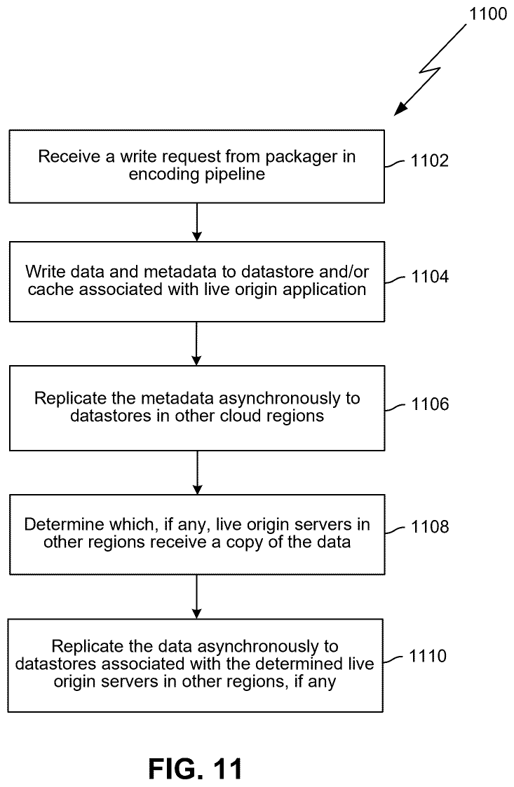

FIG. 11 is a flow diagram of method steps for multi-cloud region aware live origin servers to write data, according to various embodiments. Although the method steps are described in conjunction with the systems of FIGS. 1-4 and 10, persons skilled in the art will understand that any system configured to perform the method steps in any order falls within the scope of the various embodiments.

As shown, a method 1100 begins at step 1102, where a live origin application 142 receives a write request from a packager (e.g., packager 106(1) or 116(2)) in an encoding pipeline. The write request can request to write any technically feasible data, such as a media content item segment or manifest information.

At step 1104, live origin application 142 writes the data and corresponding metadata to datastore 144 and/or cache 146 associated with live origin server 142. Publishing stack 304 receives write request 302 from packager 106 and sends a request to write stack 306 to write data from write request 302 to datastore 144 and/or cache 146. Publishing stack 304 can also update the metadata corresponding to a segment in datastore 144 if the segment is updated in datastore 144.

At step 1106, live origin application 142 causes the metadata to be asynchronously replicated to datastores associated with live origin servers in other cloud regions. In some embodiments, each live origin application 142 causes metadata that is stored in the datastore, including metadata indicating where media content item segments and associated manifest information are stored and can be retrieved from, associated with that live origin application to be replicated to other cloud regions. For example, live origin application 142(1) in live origin server 140(1) could cause the metadata stored in the datastore associated with live origin server 140(1) to be asynchronously replicated to a datastore associated with live origin server 140(2) in another cloud region. Any technically feasible storage replication technique can be used to replicate the metadata in some embodiments.

At step 1108, live origin application 142 determines which live origin servers in other cloud regions should receive a copy of the data. The data can include media content item segments and associated manifest information. In some embodiments, the determination is based on configuration information from a packager choosing to, or not to, dual publish to live origin servers in different cloud regions. Accordingly, in contrast to the metadata that is asynchronously replicated to every other live origin server, the live origin application running in a live origin server can determine based on the configuration information which live origin server(s) in other cloud regions receive a copy of the data. It should be understood that the data can be larger in size, and therefore more computationally expensive and time consuming to replicate, than the metadata.

At step 1110, live origin application 142 causes the data to be replicated asynchronously to datastores associated with the live origin servers in other regions, if any, that were determined at step 1108. If a live origin application determines to replicate the data to other live origin server(s), the data can be replicated asynchronously to the datastore and/or cache associated with those other live origin server(s) in other cloud region(s). Any technically feasible storage replication technique can be used to replicate the data in some embodiments.

FIG. 12 is a flow diagram of method steps for multi-cloud region aware live origin servers to read data, according to various embodiments. Although the method steps are described in conjunction with the systems of FIGS. 1-4 and 10, persons skilled in the art will understand that any system configured to perform the method steps in any order falls within the scope of the various embodiments.

As shown, a method 1200 begins at step 1202, where live origin application 142 running in one cloud region receives a read request 312 for data. The read request 312 can be forwarded to the live origin application 142 by a CDN server 112 that has not cached the data being requested.

At step 1204, live origin application 142 determines whether metadata (e.g., metadata in metadata 408) about data stored in a local datastore (e.g., datastore 144) and cache (e.g., cache 146) includes a key that includes information about the requested data and information about a local encoding pipeline. The local encoding pipeline is an encoding pipeline that writes to live origin application 142. For example, a CDN stack of live origin application 142(1) could determine whether metadata stored in a local datastore includes a key associated with requested data and the encoding pipeline that includes media connector 102(1), encoder 104(1), and packager 106(1).

If the metadata includes a key associated with the requested data and a local encoding pipeline, then at step 1206, live origin application 142 reads the requested data from a local datastore or cache. In some embodiments, live origin application 142 can read the requested data according to methods 700-800, described above in conjunction with FIGS. 7-8.

On the other hand, if the metadata does not include a key associated with the requested data and the local encoding pipeline, then method 1200 continues to step 1208, where live origin application 142 determines whether metadata (e.g., metadata in metadata 408) about data stored in any other cloud regions includes a key associated with the requested data and another encoding pipeline, which is an encoding pipeline that writes to a live origin application in another cloud region. For example, a CDN stack of live origin application 142(1) could determine whether metadata stored in a local datastore includes a key associated with requested data and another encoding pipeline that includes media connector 102(2), encoder 104(2), and packager 106(2).

If live origin application 142 determines that the metadata also does not include a key associated with the data and another encoding pipeline, then live origin application 142 responds that the requested data was not found to a client application that made the read request. For example, live origin application 142 could transmit, to the client application, a response that includes a 404 error message indicating that the requested data was not found.

If live origin application 142 determines that the metadata does include a key associated with the data and another encoding pipeline, then at step 1212, live origin application 142 determines whether the data is stored in the local datastore or cache. As described above in conjunction with FIG. 10-11, the data could have been replicated from another cloud region associated with the other encoding pipeline to the local datastore and/or cache.

If the data is stored in the local datastore or cache, then at step 1214, live origin application 142 reads the data from the local datastore or cache. On the other hand, if the data is not stored in the local datastore or cache, then at step 1216, live origin application 142 requests the data from another live origin application in another cloud region associated with the other pipeline. Requesting the data from the other live origin application saves one round trip, because the CDN server that transmitted read request 312 received at step 1202 does not need to re-transmit read request 312 to the other live origin application.

After reading data from the local datastore or cache at step 1206 or 1214, or after receiving the data from the other cloud region in response to the request at step 1216, live origin application 142 returns the data to the client application at step 1218.

In sum, techniques are disclosed for improving live streaming write and read latency. In some embodiments, a distributed datastore is implemented with selective consistency support for reads and writes of media content item manifests. The manifests are tagged as being mutable because data therein can be frequently updated. By contrast, segments of the media content item are tagged as being immutable because data therein is not changed. Selective consistency support is implemented in which consistency is only verified for mutable data to avoid the unnecessary overhead of verifying consistency of immutable data that does change. Because the immutable data does not change, the immutable data can also be cached to further reduce latency when reading the immutable data. In addition, background processes to delete outdated versions of data do not need to operate on immutable data, which further reduces computational overhead.

In some embodiments, different substreams of media content item data, such as substreams of audio and video content on a bitrate ladder that have different bitrates and resolutions, are created. In such cases, the live origin application allocates a separate partition for storing each substream. When a live stream event is restarted, the live origin creates a different ID for the restarted live stream and stores data associated with the restarted live stream event in a new partition. In some embodiments, entire partitions can be deleted by performing a soft delete that makes data associated with the partitions inaccessible and then deleting the data. The live origin application can also perform hedging for read and write requests to overcome network jitter that can cause read or write timeouts. During hedging, the live origin application monitors the average time for read and write requests. If a response to a given request is taking more than the average time, the live origin sends one or more requests to other servers and returns the fastest response from one of the servers to which requests were sent.

In some embodiments, live origin applications are multi-cloud region aware. In such cases, one or more cloud regions can each host an encoding pipeline that writes to a corresponding live origin application. When a live origin application in one cloud region writes data and corresponding metadata in a datastore and/or cache of the cloud region. The metadata for segments is written to the local cloud region and asynchronously propagated to remote cloud regions while the media content item segment data is written to local region, while the live origin application determines the datastores that manifest information and media content item segments are replicated to based on configuration information indicating that a pipeline upstream component, such as a packager, is publishing (or is not publishing) media content item segments and associated manifest information to live origins in remote cloud regions. ]For read requests, the live origin searches for data associated with the read request using the metadata in the datastore. The live origin then retrieves the manifests or the segments referenced by the metadata from the same region, whether the data was written directly to the cloud region or asynchronously replicated to the cloud region.

At least one technical advantage of the disclosed techniques relative to the prior art is that the disclosed techniques reduce the latency of read and write requests processed by a live origin server by eliminating the need to maintain data versions during writing of immutable data, as well as the need to perform version checks during reading of immutable data. Further, the immutable data can be stored in a cache, from which the immutable data can be read more efficiently than from a datastore. The disclosed techniques also improve deletion speed in a distributed datastore by deleting entire partitions in which media content item segments are stored, and thereafter deleting data associated with those partitions in the background. In addition, the disclosed techniques can tolerate higher latency jitter impacting the streaming pipeline by hedging read and write requests processed by a live origin server, and the disclosed techniques use multi-cloud region aware live origin servers to request data from different cloud regions when the data is unavailable from any given cloud region. These technical advantages represent one or more technological improvements over prior art approaches.
1. In some embodiments, a computer-implemented method for storing data comprises determining whether first data to be stored is mutable data that can be modified or immutable data that is not modified, in response to determining that the first data is mutable data, storing the first data in a datastore, and in response to determining that the first data is immutable data, storing the first data in the datastore and in a cache.
2. The computer-implemented method of clause 1, further comprising receiving a request to write the first data.
3. The computer-implemented method of clauses 1 or 2, wherein whether the first data is mutable data or immutable data is determined based on a uniform resource locator (URL) included in the request.
4. The computer-implemented method of any of clauses 1-3, wherein the first data is immutable data, and the first data comprises media content data.
5. The computer-implemented method of any of clauses 1-4, wherein the first data is immutable data, and the first data comprises live streaming data.
6. The computer-implemented method of any of clauses 1-5, wherein the first data is immutable data, and a background job to delete outdated versions of data does not operate on the first data.
7. The computer-implemented method of any of clauses 1-6, wherein the first data is immutable data, and no version checking operations are performed on the first data.
8. The computer-implemented method of any of clauses 1-7, wherein the first data is mutable data, and the first data comprises manifest information associated with media content data.
9. The computer-implemented method of any of clauses 1-8, wherein the first data is mutable data, and the method further comprises performing one or more operations to check consistency of the first data.
10. The computer-implemented method of any of clauses 1-9, wherein the determining and storing steps are performed by a live origin server.
11. In some embodiments, one or more non-transitory computer-readable media store program instructions that, when executed by at least one processor, cause the at least one processor to perform the steps of determining whether first data to be stored is mutable data that can be modified or immutable data that is not modified, in response to determining that the first data is mutable data, storing the first data in a datastore, and in response to determining that the first data is immutable data, storing the first data in the datastore and in a cache.
12. The one or more non-transitory computer-readable media of clause 11, wherein the instructions, when executed by the at least one processor, further cause the at least one processor to perform the step of receiving a request to write the first data.
13. The one or more non-transitory computer-readable media of clauses 11 or 12, wherein whether the first data is mutable data or immutable data is determined based on a uniform resource locator (URL) included in the request.
14. The one or more non-transitory computer-readable media of any of clauses 11-13, wherein determining whether the first data is mutable data or immutable data comprises processing the first data.
15. The one or more non-transitory computer-readable media of any of clauses 11-14, wherein the first data is immutable data, and the first data comprises media content data associated with either a live stream or a recording.
16. The one or more non-transitory computer-readable media of any of clauses 11-15, wherein the first data is immutable data, and a background job to delete outdated versions of data does not operate on the first data.
17. The one or more non-transitory computer-readable media of any of clauses 11-16, wherein the first data is immutable data, and no version checking operations are performed on the first data.
18. The one or more non-transitory computer-readable media of any of clauses 11-17, wherein the first data is mutable data, and the first data comprises manifest information associated with media content data.
19. The one or more non-transitory computer-readable media of any of clauses 11-18, wherein the first data is mutable data, and the method further comprises performing one or more operations to check consistency of the first data prior to serving the first data to a client application.
20. In some embodiments, a system comprises one or more memories storing instructions, and one or more processors that are coupled to the one or more memories and, when executing the instructions, are configured to determine whether first data to be stored is mutable data that can be modified or immutable data that is not modified, in response to determining that the first data is mutable data, store the first data in a datastore, and in response to determining that the first data is immutable data, store the first data in the datastore and in a cache.
1. In some embodiments, a computer-implemented method for storing media content data comprises receiving first media content data, and storing the first media content data in a first plurality of servers of a datastore that are associated with a first partition.
2. The computer-implemented method of clause 1, further comprising storing metadata associated with the first media content data in a second plurality of servers associated with a second partition of the datastore.
3. The computer-implemented method of clauses 1 or 2, further comprising disabling access to the first media content data, and performing one or more background operations to delete the first media content data from the first plurality of servers.
4. The computer-implemented method of any of clauses 1-3, wherein the first media content data is encoded based on at least one of a bitrate or resolution specified in a bitrate ladder.
5. The computer-implemented method of any of clauses 1-4, further comprising storing the first media content data in a second plurality of servers of a cache that are associated with the first partition.
6. The computer-implemented method of any of clauses 1-5, further comprising transmitting, to a first server included in the first plurality of servers, a request to read the first media content data, and in response to not receiving a response from the first server for more than a threshold amount of time, transmitting, to a second server included in the first plurality of servers, the request to read the first media content data.
7. The computer-implemented method of any of clauses 1-6, wherein the threshold amount of time is an average time for responses from the first plurality of servers.
8. The computer-implemented method of any of clauses 1-7, further comprising receiving second media content data that is encoded at a different bitrate than the first media content data, and storing the second media content data in a plurality of servers associated with a second partition of the datastore.
9. The computer-implemented method of any of clauses 1-8, wherein the first media content data is associated with a live stream, and the method further comprises receiving second media content data associated with a restarting of the live stream, assigning, to the second media content data, a first identifier (ID) that is different from a second ID that is assigned to the first media content data, and storing the second media content data in a plurality of servers associated with a second partition of the datastore.
10. The computer-implemented method of any of clauses 1-9, wherein the first media content data comprises one of video data or audio data.
11. In some embodiments, one or more non-transitory computer-readable media store program instructions that, when executed by at least one processor, cause the at least one processor to perform the steps of receiving first media content data, and storing the first media content data in a first plurality of servers of a datastore that are associated with a first partition.
12. The one or more non-transitory computer-readable media of clause 11, wherein the instructions, when executed by the at least one processor, further cause the at least one processor to perform the step of storing metadata associated with the first media content data in a second plurality of servers associated with a second partition of the datastore.
13. The one or more non-transitory computer-readable media of clauses 11 or 12, wherein the instructions, when executed by the at least one processor, further cause the at least one processor to perform the steps of disabling access to the first media content data, and performing one or more background operations to delete the first media content data from the first plurality of servers.
14. The one or more non-transitory computer-readable media of any of clauses 11-13, wherein the instructions, when executed by the at least one processor, further cause the at least one processor to perform the step of storing the first media content data in a second plurality of servers of a cache that are associated with the first partition.
15. The one or more non-transitory computer-readable media of any of clauses 11-14, wherein the instructions, when executed by the at least one processor, further cause the at least one processor to perform the steps of transmitting, to a first server included in the first plurality of servers, a request to read the first media content data, and in response to not receiving a response from the first server for more than a threshold amount of time, transmitting, to a second server included in the first plurality of servers, the request to read the first media content data.
16. The one or more non-transitory computer-readable media of any of clauses 11-15, wherein the threshold amount of time is less than a maximum tolerated latency.
17. The one or more non-transitory computer-readable media of any of clauses 11-16, wherein the first media content data is encoded based on at least one of a first bitrate or a first resolution specified in a bitrate ladder, and the instructions, when executed by the at least one processor, further cause the at least one processor to perform the steps of receiving second media content data that is encoded based on a second bitrate or a second resolution specified in the bitrate ladder, and storing the second media content data in a plurality of servers associated with a second partition of the datastore.
18. The one or more non-transitory computer-readable media of any of clauses 11-17, wherein the instructions, when executed by the at least one processor, further cause the at least one processor to perform the steps of receiving second media content data associated with a restarting of the live stream, assigning, to the second media content data, a first identifier (ID) that is different from a second ID assigned to the first media content data, and storing the second media content data in a plurality of servers associated with a second partition of the datastore.
19. The one or more non-transitory computer-readable media of any of clauses 11-18, wherein assigning, to the second media content data, the first ID comprises computing the first ID based on the second ID and a random value.
20. In some embodiments, a system comprises one or more memories storing instructions, and one or more processors that are coupled to the one or more memories and, when executing the instructions, are configured to receive first media content data, and store the first media content data in a first plurality of servers of a datastore that are associated with a first partition.
1. In some embodiments, a computer-implemented method for storing data across cloud regions comprises storing first data and first metadata in a first datastore included in a first cloud region, wherein the first metadata is associated with the first data, and replicating the first metadata from the first datastore to a second datastore included in a second cloud region.
2. The computer-implemented method of clause 1, further comprising, in response to configuration information indicating to replicate the first data, replicating the first data from the first datastore to the second datastore.
3. The computer-implemented method of clauses 1 or 2, further comprising receiving, from a live origin server included in the second cloud region, a request for the first data from the first datastore based on the first metadata replicated to the second datastore.
4. The computer-implemented method of any of clauses 1-3, wherein the first data is stored in a first physical storage included in the first datastore, and the first metadata is stored in a second physical storage included in the first datastore.
5. The computer-implemented method of any of clauses 1-4, wherein the first metadata is replicated by a storage engine associated with the first datastore.
6. The computer-implemented method of any of clauses 1-5, wherein the first metadata comprises a key and a value pointing to the first data stored in the first datastore.
7. The computer-implemented method of any of clauses 1-6, wherein the key is associated with the first cloud region.
8. The computer-implemented method of any of clauses 1-7, wherein the first data comprises media content data.
9. The computer-implemented method of any of clauses 1-8, wherein the first data comprises manifest information associated with media content data.
10. The computer-implemented method of any of clauses 1-9, wherein the first metadata is replicated from the first datastore to the second datastore asynchronously.
11. In some embodiments, one or more non-transitory computer-readable media store program instructions that, when executed by at least one processor, cause the at least one processor to perform the steps of storing first data and first metadata in a first datastore included in a first cloud region, wherein the first metadata is associated with the first data, and replicating the first metadata from the first datastore to a second datastore included in a second cloud region.
12. The one or more non-transitory computer-readable media of clause 11, wherein the instructions, when executed by the at least one processor, further cause the at least one processor to perform the step of, in response to configuration information indicating to replicate the first data, replicating the first data from the first datastore to the second datastore.
13. The one or more non-transitory computer-readable media of clauses 11 or 12, wherein the instructions, when executed by the at least one processor, further cause the at least one processor to perform the step of receiving, from a live origin server included in the second cloud region, a request for the first data from the first datastore based on the first metadata replicated to the second datastore.
14. The one or more non-transitory computer-readable media of any of clauses 11-13, wherein the first data is stored in a first physical storage included in the first datastore, and the first metadata is stored in a second physical storage included in the first datastore.
15. The one or more non-transitory computer-readable media of any of clauses 11-14, wherein the first metadata comprises a key and a value pointing to the first data stored in the first datastore.
16. The one or more non-transitory computer-readable media of any of clauses 11-15, wherein the first data comprises media content data or manifest information associated with media content data.
17. The one or more non-transitory computer-readable media of any of clauses 11-16, further comprising receiving the first data from a first encoding pipeline that encodes media content data.
18. The one or more non-transitory computer-readable media of any of clauses 11-17, wherein the second cloud region is associated with a second encoding pipeline that encodes media content data.
19. The one or more non-transitory computer-readable media of any of clauses 11-18, wherein storing the first data and the first metadata in the first datastore comprises writing the first data and the first metadata to a quorum of servers in the first datastore.
20. In some embodiments, a system comprises one or more memories storing instructions, and one or more processors that are coupled to the one or more memories and, when executing the instructions, are configured to store first data and first metadata in a first datastore included in a first cloud region, wherein the first metadata is associated with the first data, and replicate the first metadata from the first datastore to a second datastore included in a second cloud region.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system. ” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for storing media content data, the method comprising:
receiving first media content data; and
storing the first media content data in a first plurality of servers of a datastore that are associated with a first partition.

2. The computer-implemented method of claim 1, further comprising storing metadata associated with the first media content data in a second plurality of servers associated with a second partition of the datastore.

3. The computer-implemented method of claim 2, further comprising:
disabling access to the first media content data; and
performing one or more background operations to delete the first media content data from the first plurality of servers.

4. The computer-implemented method of claim 1, wherein the first media content data is encoded based on at least one of a bitrate or resolution specified in a bitrate ladder.

5. The computer-implemented method of claim 1, further comprising storing the first media content data in a second plurality of servers of a cache that are associated with the first partition.

6. The computer-implemented method of claim 1, further comprising:
transmitting, to a first server included in the first plurality of servers, a request to read the first media content data; and
in response to not receiving a response from the first server for more than a threshold amount of time, transmitting, to a second server included in the first plurality of servers, the request to read the first media content data.

7. The computer-implemented method of claim 6, wherein the threshold amount of time is an average time for responses from the first plurality of servers.

8. The computer-implemented method of claim 1, further comprising:
receiving second media content data that is encoded at a different bitrate than the first media content data; and
storing the second media content data in a plurality of servers associated with a second partition of the datastore.

9. The computer-implemented method of claim 1, wherein the first media content data is associated with a live stream, and the method further comprises:
receiving second media content data associated with a restarting of the live stream;
assigning, to the second media content data, a first identifier (ID) that is different from a second ID that is assigned to the first media content data; and
storing the second media content data in a plurality of servers associated with a second partition of the datastore.

10. The computer-implemented method of claim 1, wherein the first media content data comprises one of video data or audio data.

11. One or more non-transitory computer-readable media storing program instructions that, when executed by at least one processor, cause the at least one processor to perform the steps of:
receiving first media content data; and
storing the first media content data in a first plurality of servers of a datastore that are associated with a first partition.

12. The one or more non-transitory computer-readable media of claim 11, wherein the instructions, when executed by the at least one processor, further cause the at least one processor to perform the step of storing metadata associated with the first media content data in a second plurality of servers associated with a second partition of the datastore.

13. The one or more non-transitory computer-readable media of claim 11, wherein the instructions, when executed by the at least one processor, further cause the at least one processor to perform the steps of:
disabling access to the first media content data; and
performing one or more background operations to delete the first media content data from the first plurality of servers.

14. The one or more non-transitory computer-readable media of claim 11, wherein the instructions, when executed by the at least one processor, further cause the at least one processor to perform the step of storing the first media content data in a second plurality of servers of a cache that are associated with the first partition.

15. The one or more non-transitory computer-readable media of claim 11, wherein the instructions, when executed by the at least one processor, further cause the at least one processor to perform the steps of:
transmitting, to a first server included in the first plurality of servers, a request to read the first media content data; and
in response to not receiving a response from the first server for more than a threshold amount of time, transmitting, to a second server included in the first plurality of servers, the request to read the first media content data.

16. The one or more non-transitory computer-readable media of claim 15, wherein the threshold amount of time is less than a maximum tolerated latency.

17. The one or more non-transitory computer-readable media of claim 11, wherein the first media content data is encoded based on at least one of a first bitrate or a first resolution specified in a bitrate ladder, and the instructions, when executed by the at least one processor, further cause the at least one processor to perform the steps of:
receiving second media content data that is encoded based on a second bitrate or a second resolution specified in the bitrate ladder; and
storing the second media content data in a plurality of servers associated with a second partition of the datastore.

18. The one or more non-transitory computer-readable media of claim 11, wherein the instructions, when executed by the at least one processor, further cause the at least one processor to perform the steps of:
receiving second media content data associated with a restarting of the live stream;
assigning, to the second media content data, a first identifier (ID) that is different from a second ID assigned to the first media content data; and
storing the second media content data in a plurality of servers associated with a second partition of the datastore.

19. The one or more non-transitory computer-readable media of claim 17, wherein assigning, to the second media content data, the first ID comprises computing the first ID based on the second ID and a random value.

20. A system, comprising:
one or more memories storing instructions; and
one or more processors that are coupled to the one or more memories and, when executing the instructions, are configured to:
receive first media content data, and
store the first media content data in a first plurality of servers of a datastore that are associated with a first partition.
